(19) United States
(12) Patent Application Publication
(10) Pub. No.: US 2019/0191078 A1
(43) Pub. Date: Jun. 20, 2019

(54) INFORMATION PROCESSING APPARATUS, A NON-TRANSITORY COMPUTER READABLE STORAGE MEDIUM AND INFORMATION PROCESSING METHOD

(71) Applicant: CANON KABUSHIKI KAISHA, Tokyo (JP)

(72) Inventor: Yoshihito Nanaumi, Kawasaki-shi (JP)

(21) Appl. No.: 16/205,033

(22) Filed: Nov. 29, 2018

(30) Foreign Application Priority Data
Dec. 15, 2017 (JP) 2017-241078

(51) Int. Cl. H04N 5/232; G06T 7/60; G06K 9/00; G06K 9/32; G06T 7/136; G06K 9/03

(52) U.S. Cl. CPC H04N 5/23222; G06T 7/60; G06K 9/00456; G06K 9/3208; G06K 9/00671; G06T 2207/30176; G06K 9/033; H04N 5/232945; H04N 5/232935; G06K 2209/01; G06T 7/136

(57) ABSTRACT

An apparatus determines whether a reflecting portion that strongly reflects a light of a light source is included in a captured image. And a message for prompting the user to change the shooting method is displayed when it is determined that the reflecting portion is included in the captured image.

### BACKGROUND OF THE INVENTION

### Field of the Invention

The present invention relates to an information processing apparatus, a non-transitory computer readable storage medium, and an information processing method.

### Description of the Related Art

Camera-equipped mobile terminals have become common. Along with this, business is considered in which a sales person of an insurance company or the like captures an image of a document or a card such as a certificate of insurance or a driver's license possessed by a client as a subject with the camera-equipped mobile terminal to use the captured image data. For example, character recognition processing (OCR processing) is performed on the captured image data to extract character data, and the character data is registered in a database or analyzed to be used for suggesting a solution. Therefore, the document image data captured using the camera-equipped mobile terminal desirably has image quality suitable for character recognition processing.

On the other hand, involvement of reflection of illumination light tends to occur when an image of a glossy subject (such as a Japanese driver's license) is captured. Then, the exposure of the image sensor of the camera becomes close to the saturation state (so-called whiteout) at the reflecting portion, and the difference in luminance between the text described in the reflecting portion and its background becomes small, so that the text and the background cannot be easily discriminated in an image (that is, an image not suitable for character recognition processing).

According to a technique disclosed in Japanese Patent Laid-Open No. 2008-079258, when an image of a white board is captured, a luminance distribution histogram is created so that the position of the reflecting portion is determined based on this histogram, and further a threshold value is set in the histogram of the reflecting portion to identify the text part and the background part. Then, the color of the background part in the reflecting portion is converted into the white board background color, and the color of the text part in the reflecting portion is converted into a predetermined color having lower luminance than the white board background color.

However, since the luminance values of the text and the background are very close to each other in the reflecting portion where illumination light is very strongly reflected, even if the technique as disclosed in Japanese Patent Laid-Open No. 2008-079258 is used, parts of character pixels and background pixels may cause a possibility of misjudgment in the reflecting portion as seen from the pixel level. Accuracy of character recognition results deteriorates when character recognition processing is executed on such an image in which erroneous judgment is partially made in the character pixels and background pixels. That is, there is a high possibility that an adverse effect will be made to the accuracy of character recognition processing, even if the image correction can be applied to captured image data including a portion reflecting illumination light to such a degree that humans can discriminate text by using the technique disclosed in Japanese Patent Laid-Open No. 2008-079258.

### SUMMARY OF THE INVENTION

An information processing apparatus according to the present disclosure determines whether a reflecting portion that strongly reflects a light of a light source is included in a captured image, and displays a message to prompt a user to change a shooting method, when determining that the reflecting portion is included in the captured image.

Further features of the present invention will become apparent from the following description of exemplary embodiments (with reference to the attached drawings).

### BRIEF DESCRIPTION OF THE DRAWINGS

FIG. 1 is a diagram showing an example of an appearance of a mobile terminal.

FIG. 2 is a diagram showing an example of a hardware configuration of the mobile terminal.

FIG. 3 is a diagram showing an example of a software configuration of the mobile terminal.

FIG. 4 is a diagram showing an example of a user interface (UI) of a mobile application.

FIG. 5 is a diagram showing a processing flow in a first embodiment.

FIGS. 6A-6C are diagrams showing four-sides detection processing.

FIG. 7 is a diagram showing an example of message display.

FIGS. 8A and 8B are diagrams showing an example of distortion correction processing.

FIG. 9 is a diagram showing an example of a UI for displaying an OCR result.

FIG. 10 is a diagram for illustrating a flow of glare detection processing of the first embodiment.

FIGS. 11A-11C are diagrams for illustrating an example of a binarization processing at the time of detecting glare.

FIG. 12 is a diagram for illustrating setting of character region to be set as a template.

FIG. 13 is a diagram for illustrating a flow of glare detection processing of a second embodiment.

FIGS. 14A-14C are diagrams showing an example of a character region extracted at a time when there are glare areas at different positions.

FIG. 15 is a diagram for illustrating a flow of glare detection processing of a third embodiment.

FIG. 16 is a diagram showing a processing flow in a fourth embodiment.

### DESCRIPTION OF THE EMBODIMENTS

Hereinafter, embodiments for carrying out the present invention will be described with reference to the drawings and the like. It should be noted that the embodiments do not limit the present invention, and all of the configurations described in the embodiments are not necessarily indispensable for the means for solving the problem of the present invention.

### First Embodiment

As an example of the information processing apparatus according to the first embodiment, a mobile terminal (portable terminal) having a camera function will be described as an example. The mobile terminal may be a terminal having a wireless communication function such as a smartphone or a tablet terminal, and in this case, the captured image data can also be transmitted via the wireless communication function to an external server or the like.

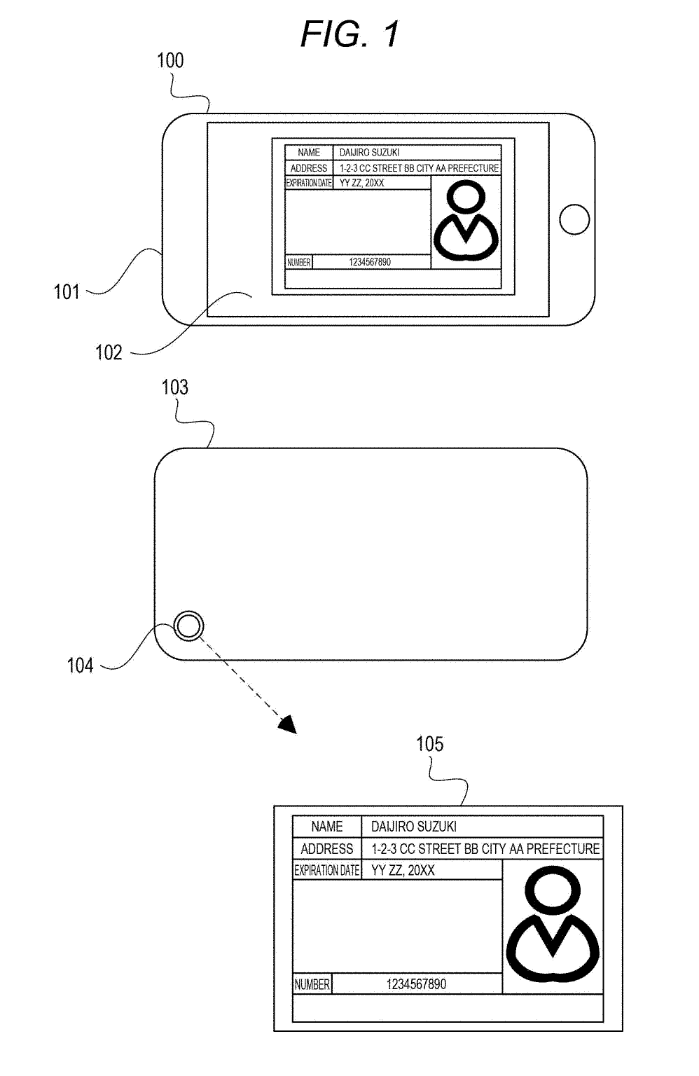

FIG. 1 is a diagram showing an example of the appearance of a mobile terminal, including an appearance of a front face 101 and an appearance of a back face 103 of a mobile terminal 100. A touch panel display (display unit) 102 is provided on the front face 101 of the mobile terminal, and has two functions of displaying an image being captured and allowing an operating instruction to be input from a user. A camera 104 for capturing moving images and still images is provided on the back face 103 of the mobile terminal. In the present embodiment, the user of the mobile terminal 100 can start the processing by capturing an image of a subject (a document on a business form or the like) 105 with the camera 104 by a mobile application (mobile app.) to be described later. The subject 105 is not limited to a paper document of a standard size such as A4 or A3 and may be a paper document of a non-standard size, and not only a paper document such as a business form, but also a subject of various sizes (license, business card, photo, various cards, etc.). A mobile application to be described later can capture the image of the subject 105 using the camera 104 and output the image to the touch panel 102.

### Hardware Configuration

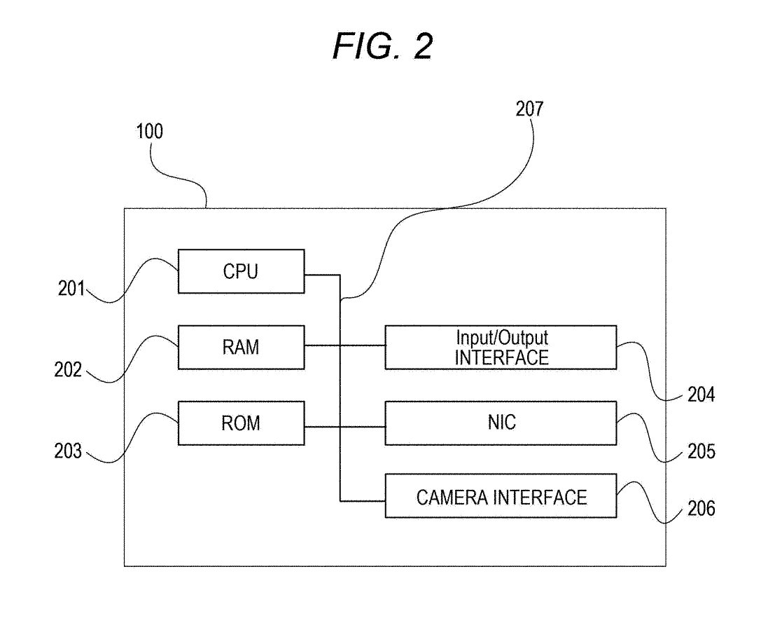

FIG. 2 is a diagram showing an example of the hardware configuration of the mobile terminal 100, and includes various units (201 to 207). A central processing unit (CPU) 201 is a processor that functions as a processing unit for implementing various types of processing of a flowchart to be described later by executing various programs. A random access memory (RAM) 202 is a unit for storing various types of information. Further, the RAM 202 stores various types of information, and is also used as a temporary work storage area of the CPU 201. A read only memory (ROM) 203 is a storage unit that stores various programs and the like. The CPU 201 loads the program stored in the ROM 203 into the RAM 202 and executes the program. The storage medium storing the program for implementing the present disclosure is not limited to the ROM 203, and may be a computer readable storage medium such as a flash memory like a USB memory etc., a hard disk drive (HDD), a solid state drive (SSD). Further, the program is not limited to the program stored in the storage medium of the mobile terminal 100, and thus may be one downloaded via a wireless network at the time of execution, or may be a web application to be executed on a web browser. Note that all or a part of the processing related to the function of the mobile terminal 100 and the sequence to be described later may be achieved by using dedicated hardware.

An input/output interface 204 communicates with the touch panel 102 and performs transmission of display data, reception of operating instruction data from a user, and the like. A network interface card (NIC) 205 is a unit for connecting the mobile terminal 100 to a network (not shown) via wireless communication or the like.

A camera interface 206 is an interface for acquiring image data (moving image, still image) of the subject 105 captured by the camera 104. Each of the units described above is configured to be cable of transmitting and receiving data via the bus 207.

### Software Configuration

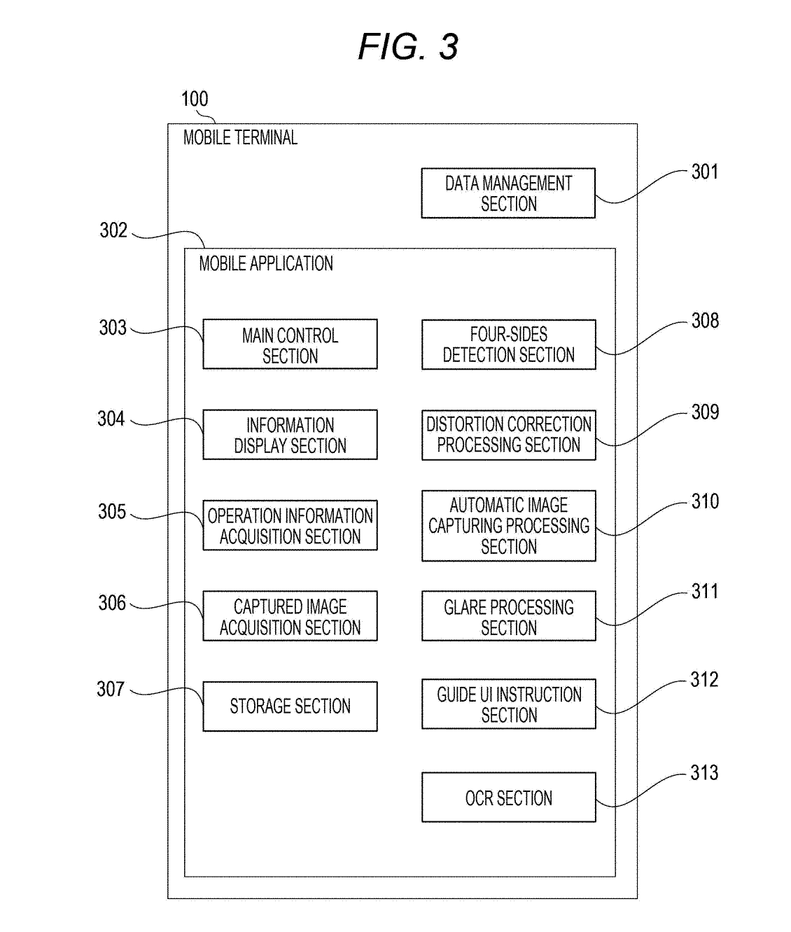

Next, an example of functional module configuration of software (mobile application) in the mobile terminal 100 will be described. The program achieving each processing section shown in FIG. 3 is stored in the ROM 203 or the like as described above.

An operating system (OS) (not shown) of the mobile terminal 100 has a data management section 301. The data management section 301 manages images and application data. The OS provides a control application programming interface (control API) for using the data management section 301. Each application acquires and stores images and application data managed by the data management section 301 by using the control API.

A mobile application 302 is an application executable in the mobile terminal 100. The mobile application 302 performs various data processing on the image data of the subject 105 captured via the camera interface 206.

A main control section 303 controls each module section (304 to 313) constituting the mobile application 302.

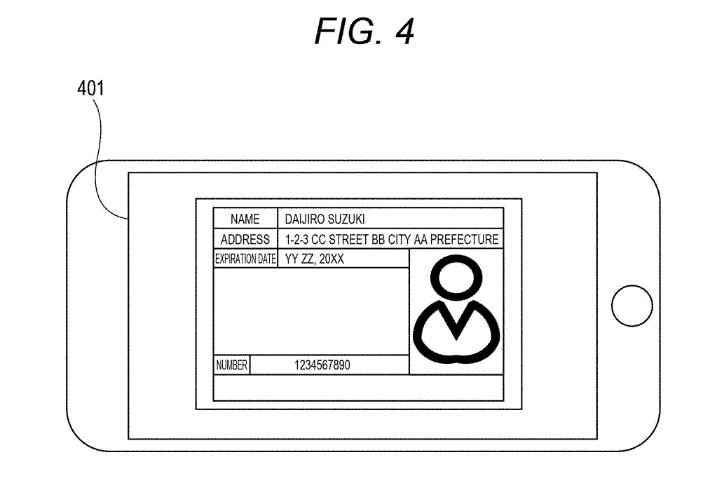

An information display section 304 provides the user with the user interface (UI) of the mobile application 302 in accordance with an instruction from the main control section 303. A screen 401 in FIG. 4 is a diagram showing an example of a UI screen provided by the mobile application 302. The screen 401 of the mobile terminal is displayed on the touch panel 102 of the mobile terminal 100, and displays an image captured via the camera 104, and accepts operation by the user (user's operation) on the displayed image etc. via the displayed UI. Note that the form of the UI screen of the mobile application 302 (the display position, size, scope, arrangement, display content and the like of captured images, operation buttons, etc.) is not limited to the form shown in FIG. 4, and an appropriate configuration enabling the function of the mobile application 302 can be employed.

An operation information acquisition section 305 acquires information on the user's operation made on the UI screen displayed by the information display section 304 and notifies the main control section 303 about the acquired operation information. For example, when the user touches the UI screen with a hand, the operation information acquisition section 305 receives the information on the position of the touched screen area and transmits information on the detected position to the main control section 303.

A captured image acquisition section 306 acquires captured images through the camera interface 206 and the camera 104 according to an instruction from the main control section 303, and stores the captured images in a storage section 307. When the captured image is to be processed immediately, the captured image acquisition section 306 may directly transmit the image to the main control section 303 or a four-sides detection section 308. In addition, the captured image acquisition section 306 acquires the image resolution value at the time of image capturing and transmits the image resolution value to the main control section 303.

The storage section 307 stores the captured image acquired by the captured image acquisition section 306. Further, the captured image having been stored can be deleted by an instruction of the main control section 303.

The four-sides detection section 308 acquires four-sides (paper edges) information of the document in the image by executing edge detection processing or the like on the image acquired by the captured image acquisition section 306 and stored in the storage section 307. The four-sides information includes position coordinates in the captured image with respect to the four apices of the quadrilateral formed by the boundary lines between the document and the background in the captured image. For detection of four-sides information, although the detection performed by combining edge detection methods such as Hough transformation and Canny algorithm is conceivable, a detection method is preferably used in which the detection result is hardly influenced by noise or the like due to the background of the document, considering that image capturing is made under various circumstances.

A distortion correction processing section 309 obtains distortion correction information (distortion correction parameter) for correcting distortion so that the detected quadrilateral fits the shape of the subject (rectangle of the aspect ratio) based on the four-sides information detected by the four-sides detection section 308 and the shape information of the document of the subject (information on the length of each side and the aspect ratio), and performs distortion correction on the captured image by using the distortion correction information. When the subject is a paper document of a fixed size such as A4 or A5 or a subject of a known size such as a license, the known size is used for the shape information of the subject document. When the shape of the subject is unknown, the size of the subject document may be estimated based on the four-sides information detected by the four-sides detection section 308. In the present embodiment, distortion correction parameters are obtained for correcting the distortion by using information on four sides which are the boundary between the document and the background, but the configuration may be made so that the distortion can also be corrected on the basis of the object (information on ruled lines and base lines of text) described in the document.

When it is determined that there is no strong reflecting portion due to a light source (illumination light or the like) in the captured image by a glare processing section to be described later and an automatic image capturing processing section 310 determines that an image of the subject is captured with an image size available for OCR (image capturing is performed with a size larger than a predetermined size) based on the four-sides information detected by the four-sides detection section 308, the automatic image capturing processing section 310 stores captured image in the storage section 307 while regarding the image being captured as an image suitable for character recognition processing.

A glare processing section 311 determines whether there is a reflecting portion by a light source such as illumination light or the like in the captured image and detects the position of the reflecting portion and the intensity of the reflected light in the case of presence of the reflecting portion. Hereinafter, a strongly reflecting portion by a light source of illumination light etc. will be referred to as “glare” and a processing of detecting the position of the reflecting portion and intensity of light will be referred to as “glare detection processing”.

A guide UI instruction section 312 instructs the information display section 304, via the main control section 303, to display the guide UI corresponding to the result of the glare detection processing in the glare processing section 311.

An OCR section 313 performs character recognition processing (OCR processing) on the image in which distortion has been corrected by the distortion correction processing section 309, and extracts text information.

### Processing Flow

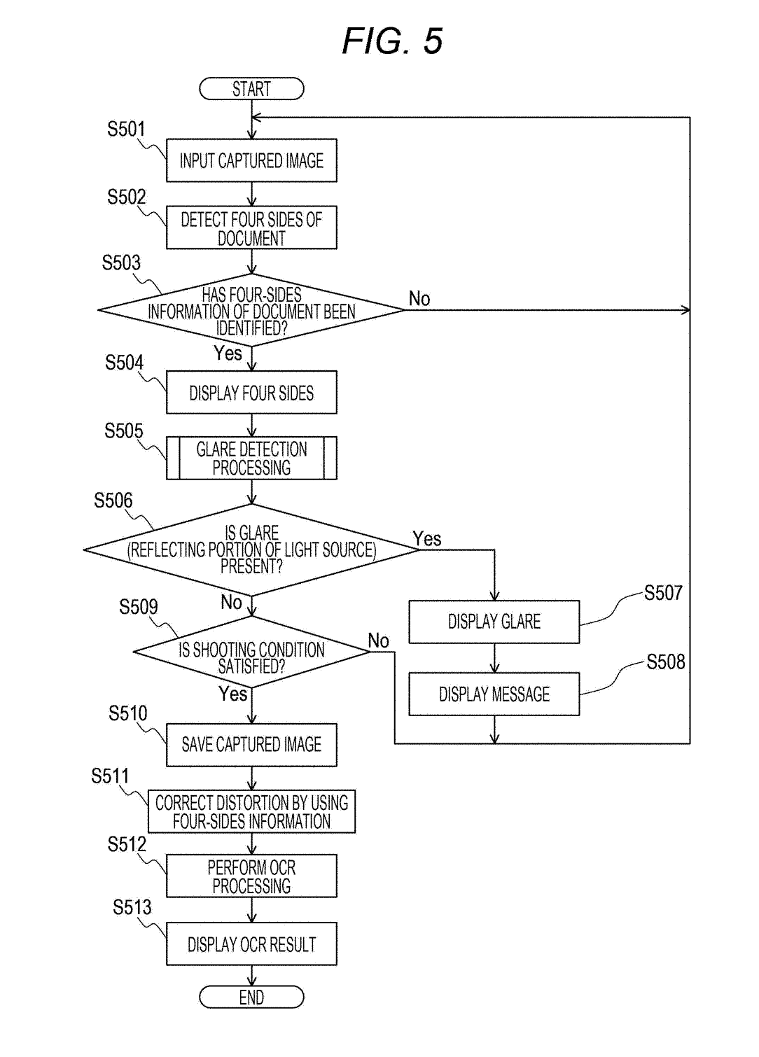

With reference to FIG. 5, the processing flow of the present disclosure implemented by the CPU 201 of the mobile terminal 100 executing the mobile application 302 will be described. This flow is triggered by the activation of the mobile application 302 in the mobile terminal 100 by a user's operation.

In step S501, the captured image acquisition section 306 acquires a captured image via the camera interface 206. For example, it is assumed that the camera interface 206 enables capturing of moving images of 30 frames per second, and the captured image acquired in step S501 is one of the captured images constituting the moving image.

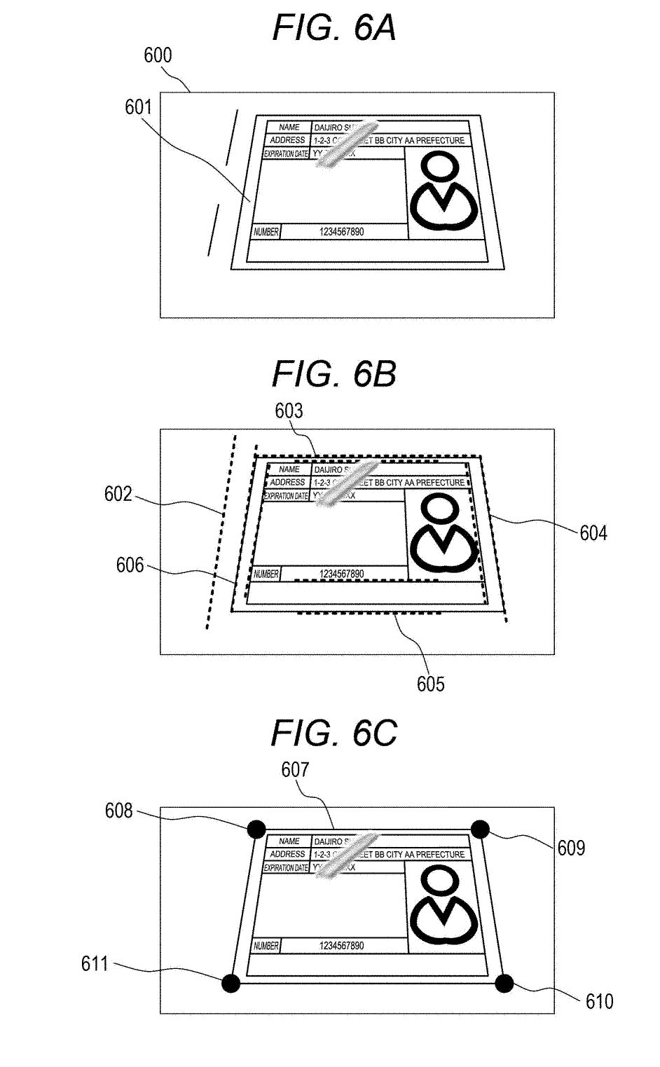

In step S502, the four-sides detection section 308 detects the four sides of the subject document (document or card) included in the captured image and obtains the four-sides information. Details of the four-sides detection processing will be described with reference to FIG. 6. First, the four-sides detection section 308 detects a straight line (edge of the document) by applying Hough transformation or the like to the captured image, and identifies a candidate line segment group which is a candidate for four sides of the document. FIG. 6A is a captured image 600, and an area 601 of a document (a subject such as a document or a driver's license) is included in the captured image. FIG. 6B is a diagram showing a case where a group of candidate line segments detected by using the Hough transformation or the like from the captured image 600 is superimposed on the captured image. In the captured image 600, since a line described in the document itself and a background other than the document (a pattern of a table on which the document is placed, for example) are also shown, a candidate line segment group detected from the captured image includes line segments other than the four sides of the document (the paper edge of the document) (a candidate line segment 602, for example). From these, candidate line segments 603, 604, 605 and 606 whose possibility of composing respective sides of the upper side, right side, lower side, and left side of the region corresponding to the document is determined as highest are identified. As a method of identifying candidate line segments that are highly likely to constitute respective sides of the region corresponding to the document from the candidate line segment group, identification is carried out, for example, by evaluating each quadrilateral formed by freely selected four candidate line segments out of the candidate line segment group. Evaluation of a quadrilateral composed of freely selected four candidate line segments may be performed based on geometric information such as the ratio of the lengths of the opposite sides, the sizes of the inner angles, the aspect ratio, and the like. Alternatively, the evaluation may be performed based on the image content obtained by comparing the tint and variance of the inside and the outside with respect to the line segments constituting a quadrilateral. FIG. 6C is an image in which a quadrilateral area 607 constituted by four sides of the document identified from the candidate segment group is displayed on the captured image 600. When the candidate line segments 603 to 606 are identified as the four sides of the document, intersection points of extended lines of respective candidate line segments are identified as apices 608, 609, 610 and 611, and the quadrilateral area 607 is a quadrilateral area surrounded by line segments connecting the apices 608 to 611 (hereinafter referred to as four-sides information).

In step S503, the main control section 303 of the mobile application 302 determines whether the detection of the four-sides information of the document has succeeded in step S502, and when it is determined that the four-sides information of the document can be identified (Yes), the processing proceeds to step S504. On the other hand, when it is determined that the four-sides information of the document cannot be identified (No), the processing proceeds to step S501.

In step S504, the information display section 304 of the mobile application 302 displays, on a screen 400, an image obtained by overlaying lines (for example, red lines) representing the detected four sides in the captured image by using the four-sides information acquired in step S502.

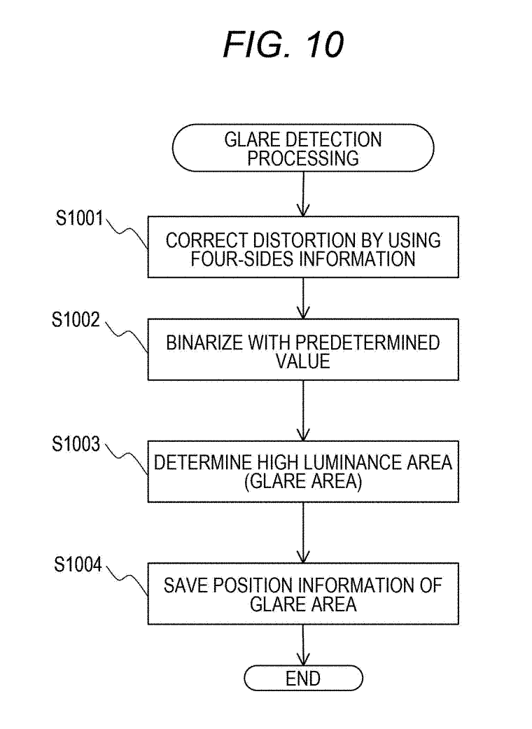

In step S505, the glare processing section 311 detects a glare (strongly reflecting portion) from the inside of the region corresponding to the document by executing the glare detection processing on the region corresponding to the document surrounded by the four sides detected in S502, and obtain the position of the glare if there is the glare. Details of the glare detection processing will be described later with reference to FIG. 10.

In step S506, the main control section 303 of the mobile application 302 determines whether a glare (a strongly reflecting portion of the light source) is detected in step S505, and the processing proceeds to step S507 when it is determined that there is a glare (Yes). On the other hand, when it is determined that there is no glare (No), the processing proceeds to step S509.

In step S507, the guide UI instruction section 312 of the mobile application 302 overlays the captured image with a guide showing the position of the glare by using the position information of the glare detected in step S505 and displays the guide on the screen 400.

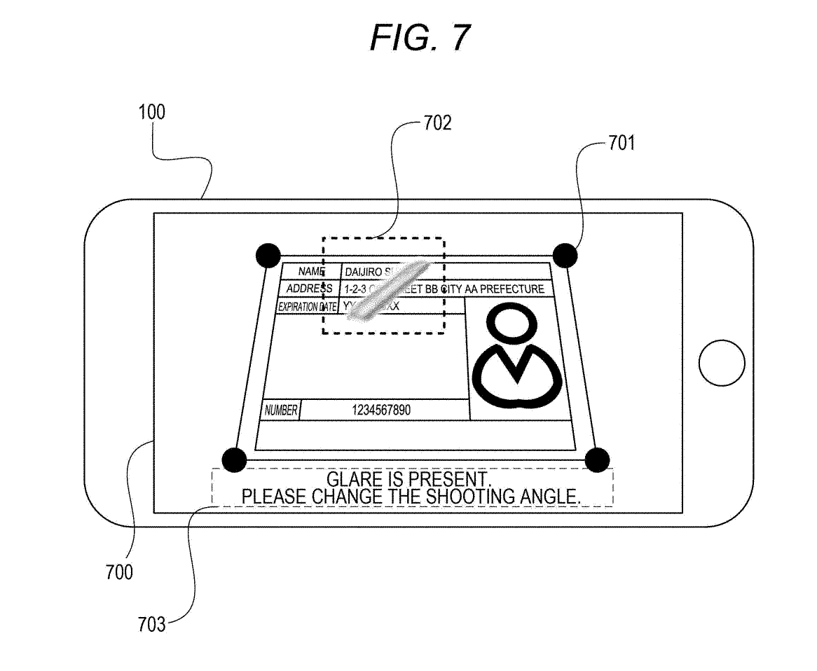

Furthermore, in step S508, the guide UI instruction section 312 of the mobile application 302 displays a message on the screen for prompting the user to change the shooting method because the glare is involved in the captured image. FIG. 7 shows an example of a screen 700 of the mobile terminal 100 displaying the shooting guide UI. The information display section 304 displays captured images acquired by the captured image acquisition section 306 on the entire surface of the screen 700, and shooting guides UIs (701 to 703) are displayed thereon. A guide UI 701 is a display example of apices constituting the four sides of the document displayed by the processing of step S504. A guide UI 702 is an example of a guide showing the position of the glare displayed by the processing of step S507. The guide UI 703 is an example of a message displayed by the processing of step S508, and the message “Glare is present. Please change the shooting angle” is displayed. In addition, the message may be anything as long as the message means that “a reflecting portion is present, so please change the shooting method (shooting angle and shooting location)”.

In step S509, the main control section 303 of the mobile application 302 determines whether a predetermined shooting condition is satisfied. When it is determined that the predetermined shooting condition is satisfied, the processing proceeds to step S510, and when it is determined that the predetermined shooting condition is not satisfied, the processing proceeds to step S501. The determination as to whether the predetermined shooting condition is satisfied in S509 is a determination as to whether the mobile terminal is stationary, for example. When the mobile terminal is moving, the captured image to be processed tends to be an image captured with a camera shake, which leads to deterioration in accuracy of character recognition processing. Since the captured image acquired when the mobile terminal is stationary is a captured image without a camera shake, the captured image at that time is automatically saved and character recognition processing is performed. The determination as to whether the mobile terminal is stationary can be made using information from a gyro sensor (not shown) or the like possessed by the mobile terminal. In addition, whether the mobile terminal is moving or stationary may be determined based on whether the feature point in the captured image is moving or stationary by comparing the feature points between the currently captured image and the captured image one frame before in the moving image during shooting. Further, as the predetermined shooting condition, other conditions (for example, whether the shutter speed is not less than a predetermined value or the like) may also be checked.

In step S510, the main control section 303 instructs the automatic image capturing processing section 310 to automatically acquire the captured image and store the image in the storage section 307. Regarding the captured image to be stored in S510, captured images (images input as a moving image) processed in S502 to S509 may be saved as they are or it may be instructed to capture a still image via the captured image acquisition section 306 and the camera 104 at the time of determining that the predetermined shooting condition is satisfied in S509, and the still image is stored as a captured image to be subjected to character recognition processing.

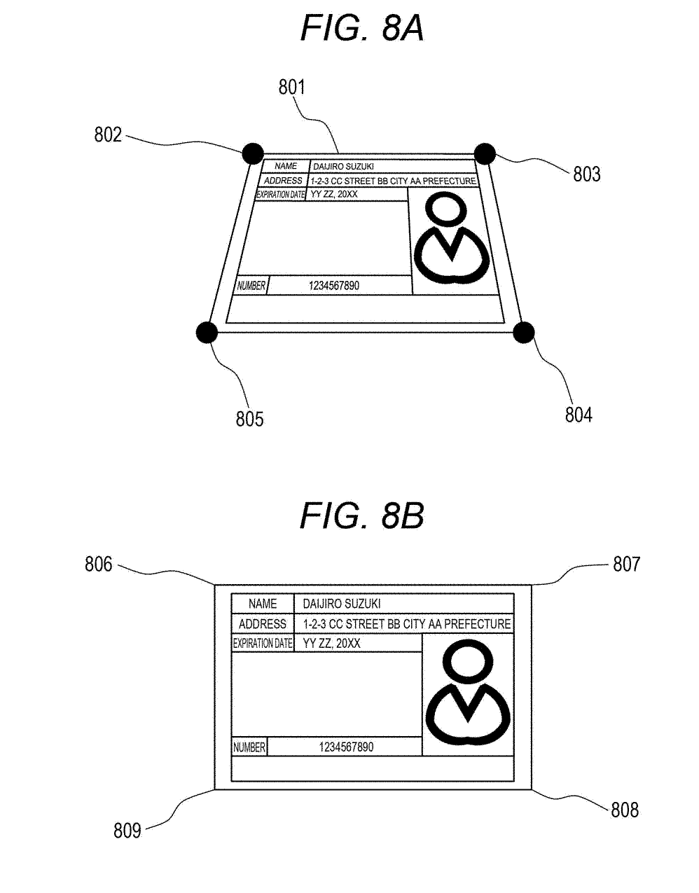

In step S511, the distortion correction processing section 309 calculates distortion correction information (distortion correction parameter) based on the four-sides information detected by the four-sides detection section 308, and uses this distortion correction information to perform correction processing of the image in the region corresponding to the document of the captured image. This distortion correction information is a projective transformation matrix, in consideration for also the case where the quadrilateral area is distorted in a trapezoid. This projective transformation matrix can be calculated by a known method based on the four-sides information detected by the four-sides detection section 308 and the aspect ratio of the document image required to be outputted after correction (vertical and horizontal sizes of documents to be shot). When priority is given to the processing speed, the matrix may be calculated using affine transformation matrix or simple magnification as distortion correction information. When the distortion correction information is determined, the distortion correction processing section 309 can apply a distortion correction processing to the quadrilateral area of the captured image, thereby extracting the quadrilateral area from the captured image and outputting the corrected image. For example, distortion correction information is calculated so that the image of a quadrilateral area 801 (the image surrounded by the apices 802, 803, 804 and 805) in the captured image of FIG. 8A has the vertical and horizontal size (the rectangular size to be defined by apices 806, 807, 808 and 809) of the output image and, distortion correction is performed on the corrected image as shown in FIG. 8B by using the calculated distortion correction information.

In step S512, the OCR section 313 executes character recognition processing (OCR processing) on the corrected image subjected to the distortion correction processing in step S511, and acquires text information of the character recognition result.

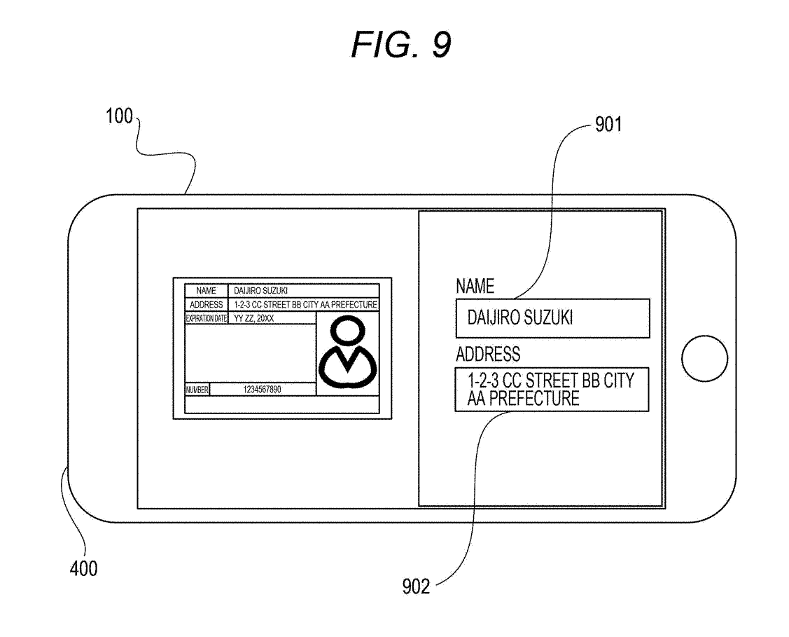

In step S513, the information display section 304 displays the corrected image obtained by the distortion correction processing in step S511 and the character recognition result acquired in step S512 in accordance with an instruction from the main control section 303. FIG. 9 shows an example of the screen 400 of the mobile terminal 100 which is displaying character recognition results. The character string determined as a name in the character recognition result is displayed in an area 901, and the character string determined as an address in the character recognition result is displayed in an area 902.

### Detailed Flow of the Glare Detection Processing

Next, details of the glare detection processing in step S505 will be described with reference to FIG. 10.

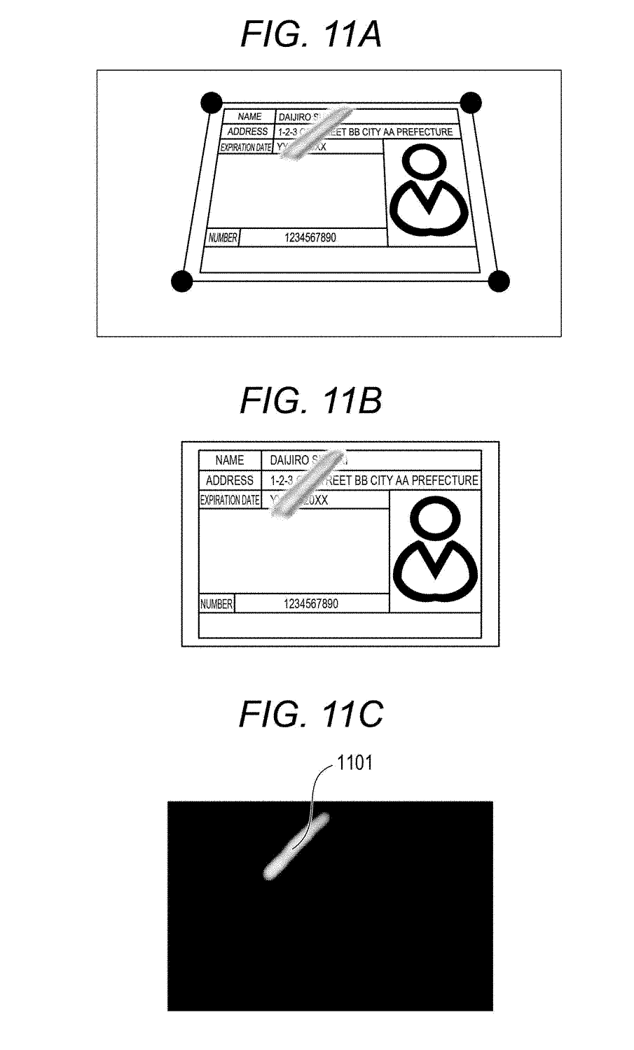

In step S1001, the glare processing section 311 instructs the distortion correction processing section 309 to perform distortion correction processing based on the four-sides information obtained in S502. As the distortion correction algorithm, an algorithm similar to the algorithm described for step S511 may be used. For example, when the distortion correction processing is executed on the region corresponding to the document in the captured image as shown in FIG. 11A, the corrected image as shown in FIG. 11B is obtained.

In step S1002, the glare processing section 311 binarizes the image whose distortion has been corrected in S1001 with a predetermined threshold value. The predetermined threshold value is set as a threshold value for discriminating high luminance pixels. For example, when the luminance value is represented by 8 bits (0 to 255), a predetermined threshold value is set to 255, and the image is converted into a binary image by setting the color of pixels having luminance values equal to or higher than the threshold value to white and setting the color of pixels having luminance values lower than the threshold value to black. In this case, a binary image can be obtained in which only the pixel whose exposure is completely saturated in the image sensor of the camera (so-called whiteout pixel) is set as a white pixel. The predetermined threshold value is not limited to 255. For example, the predetermined threshold may be set to a value lower than 255 (for example, 240) in the case of detecting pixels including ones whose exposure is close to the saturation.

In step S1003, when detecting a connected region (an area in which pixels of high luminance are connected) of white pixels having an area larger than a predetermined area in the binary image converted in S1002, the glare processing section 311 determines the white pixel connected region to be a glare area (a region of a strongly reflecting portion). Further, a region of white pixels smaller than a predetermined area is determined as noise. When binarization processing in step S1102 is performed on the image of FIG. 11B, a binary image as shown in FIG. 11C is obtained, and when the processing in S1003 is performed on the binary image of FIG. 11C, a glare area 1101 is detected.

In addition, in the case where an image of a document is captured without including any glare, there may be a case where the white background inside the document (white grounding portion of the document) has pixels with high luminance depending on the situation such as white balance at the time of shooting. In order to prepare for this case, a configuration may be made so that it is determined that the glare is not included when the size of the circumscribed rectangle of the connected region of white pixels is close to the size of the image in which distortion has been corrected in S1001.

In step S1004, the glare processing section 311 stores the position information of the area determined as a glare (the glare portion) in the storage section 307. In the example of FIG. 11C, the position information of the glare area 1101 is stored in the storage section.

As described above, according to the first embodiment, whether there is a glare (a strongly reflecting portion of the light source) in the region corresponding to the document of the captured image is determined, and when it is determined that there is no glare, the captured image can be automatically stored to perform predetermined processing (character recognition processing and the like). On the other hand, when it is determined that there is a glare, a message is displayed and the user is prompted to change the shooting method (changing the shooting angle or shooting location) to obtain a high-quality image.

There may be a camera adjustment step that changes the exposure setting value of the camera at the time of transition to S501 after displaying the message in S508.

### Second Embodiment

In the case where the layout of the document of the subject is known (that is, in the case where the position in which the object such as text is described and the position of the blank area in which nothing is described are known in the subject in advance), even if there is a glare in the blank area, text can be recognized in many cases. Therefore, in the second embodiment, when an image of a document whose layout is known is captured, it is determined whether the position of the detected glare area overlaps with a position at which an object such as text or the like may be described, and when no overlapping is present, processing in the subsequent stage such as character recognition is executed even if there is a glare area.

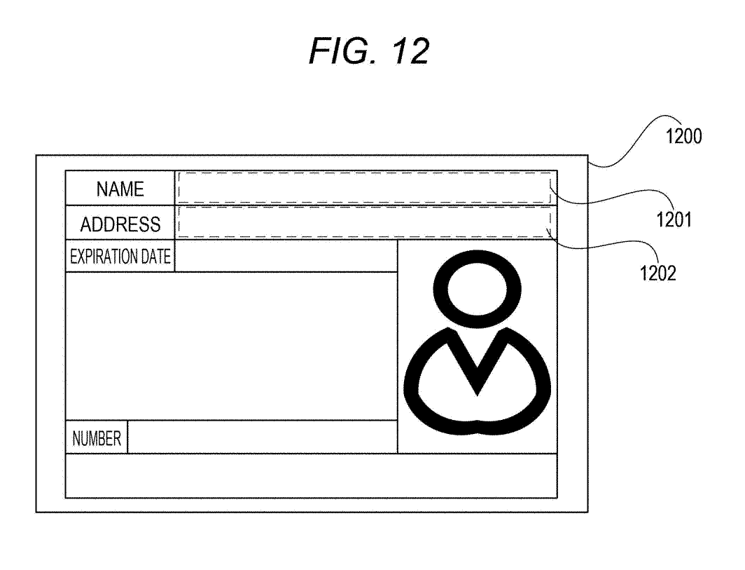

Which part of the subject should be set as a processing target region for character recognition processing or the like is determined in advance, and the setting is held as a template of the subject (layout information on the subject). FIG. 12 shows an example of a template 1200. An area 1201 is an area in which the name is described, and an area 1202 is the area in which the address is described, and these areas are regarded as processing target regions to be subjected to character recognition processing, and position coordinates of each area are defined in the template.

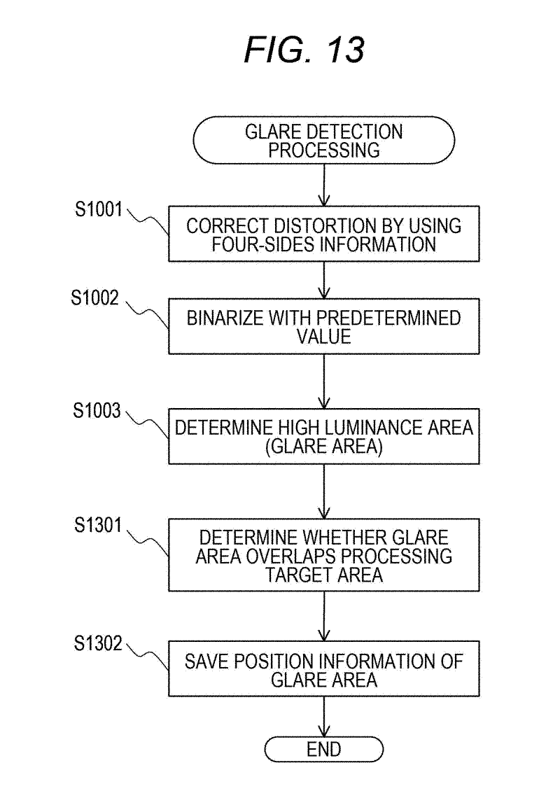

With reference to FIG. 13, a description will be given of the glare detection processing of the second embodiment. The glare detection processing in FIG. 13 is an alternative to the glare detection processing described in the first embodiment with reference to FIG. 10, and the processing in S1001 to S1003 is the same as in the first embodiment, so that a detailed description thereof will be omitted.

In step S1301, the glare processing section 311 of the mobile application 302 compares the position coordinates of the glare area detected in S1003 with the position coordinates of the processing target region defined in advance in the template of the subject of the shooting target. When the glare area detected in S1003 overlaps with any of the processing target regions (the area 1201 and area 1202), the position information of the glare area is stored in the storage section in step S1302.

On the other hand, when it is determined that the glare area detected in S1003 does not overlap with any of the processing target regions, the position information of the glare area is not stored in S1302 as it is considered that the glare area does not affect the processing in the subsequent stage. As a result, in the processing of determining the presence or absence of a glare in S506, it is determined that there is no glare area affecting the character recognition processing in the subsequent stage, and the processing proceeds to S509.

According to the second embodiment, when an image of a subject whose processing target region is defined as a template in advance is captured, even if there is a glare in the captured image, the captured image is automatically acquired when the glare area does not overlap with the processing target region, and processing can proceed to the subsequent stage. Further, when the detected glare area overlaps with the processing target region, a message can be displayed in S508 to prompt the user to change the shooting method.

### Third Embodiment

In the second embodiment described above, in the case where the template of the subject document is set in advance, it is determined whether the glare area is at a position affecting processing in the subsequent stage. In the third embodiment, when a template of the subject document is not set in advance, a plurality of captured images having different positions of the glare area is used to determine whether the position of the glare area affects the processing in the subsequent stage. The third embodiment is particularly suitable for a case where there is a plurality of illumination lamps on the ceiling or the like, and a glare area appears due to reflected light of any of illumination lamps even if the shooting angle is changed.

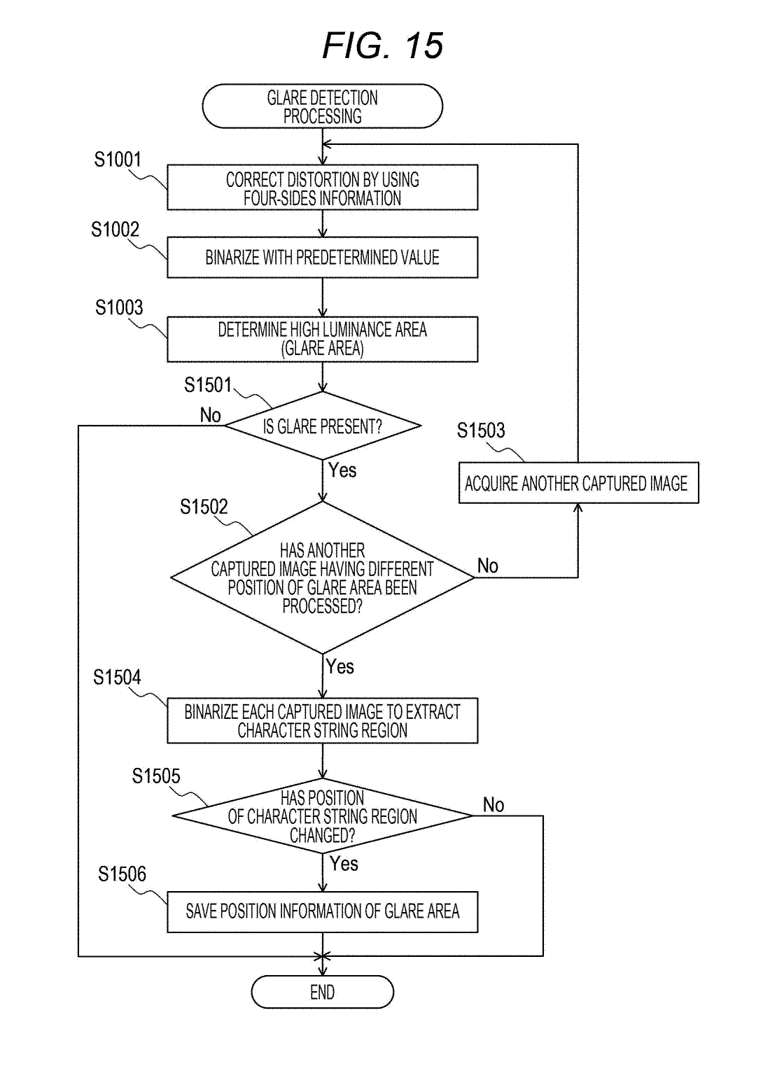

With reference to FIG. 15, a description will be given of the glare detection processing of the third embodiment. The glare detection processing in FIG. 15 is an alternative to the glare detection processing described in the first embodiment with reference to FIG. 10, and the processing of S1001 to S1003 is the same as the processing of the first embodiment, so that detailed description thereof will be omitted.

In step S1501, the glare processing section 311 determines whether a glare area is detected in S1003, and the processing proceeds to S1502 when there is a glare area, and terminates the processing concluding that glare area is not present when there is no glare area.

In step S1502, the glare processing section 311 determines whether to have processed another captured image having completely different position of the glare area (that is, another captured image whose position of the glare area does not have an overlap). When it is determined that another captured image having a different position of the glare area has not been processed, the processing proceeds to step S1503 to acquire a captured image of another frame. At this time, if the user tilts the mobile terminal slightly, the shooting angle changes and the position of the glare also shifts. Then, processing of S1001 to S1003 is performed on the acquired another captured image to determine the position of the glare area. When it is determined that another captured image having a different position of the glare area has been processed in S1502, the processing proceeds to step S1504.

In step S1504, the glare processing section 311 performs known binarization processing (for example, the Otsu binarization method) on each of a plurality of captured images in which the positions of the glare areas are completely different, thereby obtaining a plurality of binary images in which a character string can be detected. Then, in each of the plurality of binary images, a character string region is detected. As a method of detecting the character string region, a known method can be used. For example, there is a method of determining the circumscribed rectangle of the black pixel cluster as a character area constituting one character and further extracting a combination of certain character areas within a certain distance as a character string region, when a cluster of connected black pixels is detected in each binary image and the size of the detected black pixel cluster is close to the assumed text size. As another method of detecting the character string region, a method of taking histograms in the horizontal direction and the vertical direction in each binary image and identifying the character string region based on the shapes of the histograms may be adopted.

In step S1505, the glare processing section 311 determines whether the position and the number of character string regions detected from each of a plurality of captured images having different glare area positions have changed. When it is determined that the position and the number of the character string regions have changed, since it is considered that an accurate character string region has not been detected because the glare region overlaps the character string, the glare area included in the captured image is considered to affect the character recognition processing in the subsequent stage. Therefore, when it is determined that the position of the character string region has changed, the processing proceeds to step S1506, in which the position information of the glare area is saved so that the glare area and the message are displayed in S507 to S508 in FIG. 5.

On the other hand, when it is determined that the position and the number of the character string regions detected from each of the plurality of captured images having different positions of the glare area have not changed, it is considered that the glare area included in the captured image does not overlap the character string and the glare area included in the captured image does not affect the character recognition processing in the subsequent stage. Therefore, in this case, the position information on the glare area is not saved. As a result, in the processing of determining the presence or absence of a glare in S506, it is determined that there is no glare area affecting the character recognition processing in the subsequent stage, and the processing proceeds to S509.

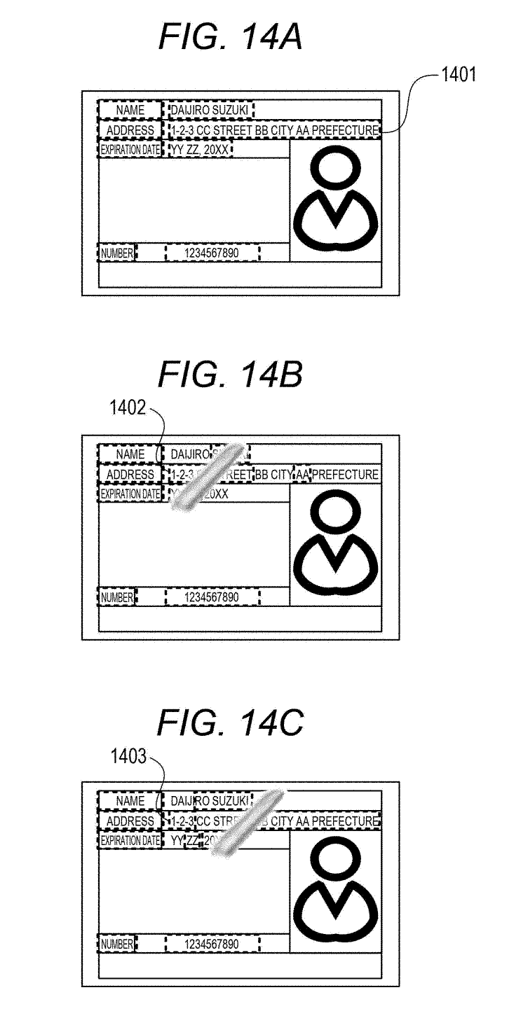

FIG. 14A shows an example in which a character string region is detected when there is no glare during shooting of the subject 105, and a plurality of detected character string regions is indicated by a broken-line rectangle. FIGS. 14B and 14C are each an example in which a character string region is detected when there is a glare area during shooting of the subject 105, and the positions of the glare areas do not overlap each other in FIGS. 14B and 14C. A character string region 1401 detected in FIG. 14A is in a state like character string regions 1402 and 1403 in FIGS. 14B and 14C due to the influence of the glare area. As shown in FIGS. 14B and 14C, the character string regions 1402 and 1403 respectively detected in the plurality of captured images having different glare areas differ in position and size, so that it can be seen that the glare area detected in FIGS. 14B and 14C overlaps with the character string.

As described above, in the third embodiment, it is determined whether the position and number of character string regions extracted from a plurality of captured images having different positions of the glare areas are the same, and when it is determined that the position and number are the same, it is possible to determine that the glare area included in the captured image does not affect the processing in the subsequent stage and to proceed to the processing in the subsequent stage. In addition, when the detected glare area overlaps with the character string region, a message is displayed in S508 and the user can be prompted to change the shooting method so that the glare area does not overlap with the character string region.

### Fourth Embodiment

In the fourth embodiment, even if a glare area is detected, a message is not displayed when the intensity of the glare is not so strong and therefore a character string can be detected by image correction, and the processing proceeds to the character recognition processing in the subsequent stage after the image correction.

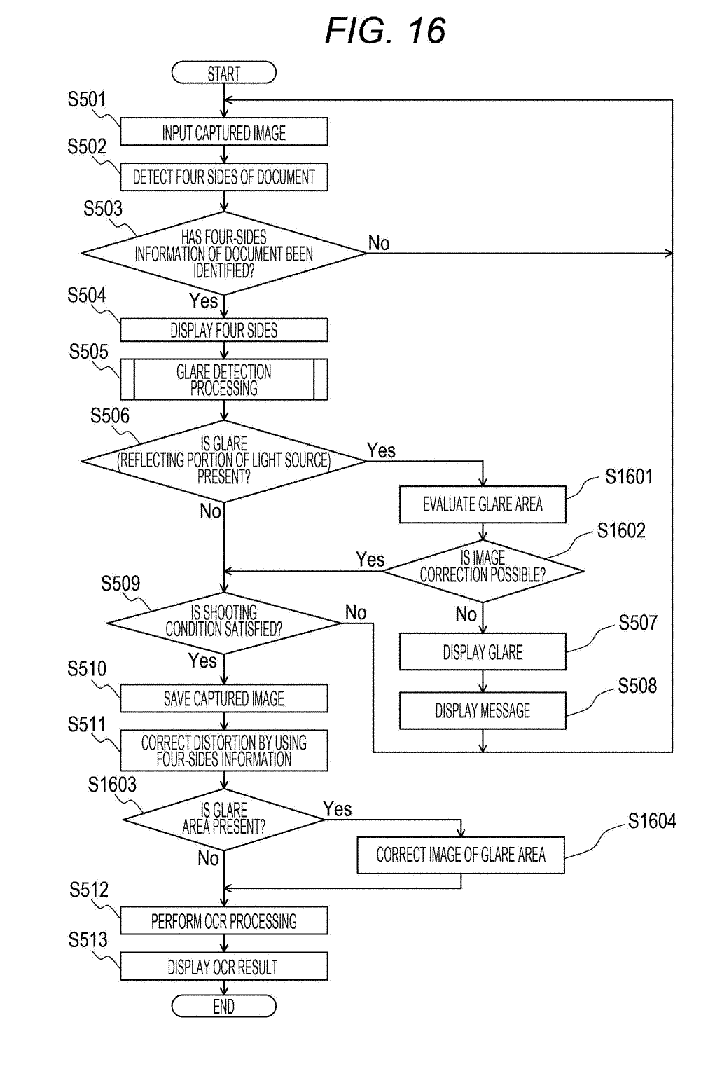

Although the processing flow of the fourth embodiment will be described with reference to FIG. 16, a detailed description of steps similar to the processing flow shown in FIG. 5 of the first embodiment will be omitted.

When determining that there is a glare area in step S506, the glare processing section 311 evaluates whether the detected glare area can be handled by image correction in step S1601. For example, from the captured image, the image of the portion corresponding to the position of the glare area detected in S505 is set as the evaluation target. Then, a binarization threshold value is obtained based on the luminance histogram extracted from the partial image of the evaluation target, and binarization of the partial image of the evaluation target is executed using the binarization threshold value, whereby it is determined whether a black pixel cluster having similar size to the assumed text size can be extracted. When the black pixel cluster constituting a text can be extracted, the glare processing section 311 determines that the situation can be handled with image correction in step S1602 and the processing proceeds to step S509. On the other hand, when a black pixel cluster constituting a text cannot be extracted, the processing proceeds to steps S507 and S508 to display a glare area and a message. In the evaluation of the glare area in step S1601 described above, the evaluation is made based on whether the black pixel cluster can be extracted, but the present disclosure is not limited thereto. For example, when a character recognition processing is executed based on the extracted black pixel cluster to obtain a character recognition result candidate whose reliability is equal to or greater than a predetermined threshold value, it may be determined that the situation can be handled with the image correction, and when the reliability is lower than the threshold value, it may be determined that the situation cannot be handled with the image correction.

In step S1603, the mobile application 302 determines whether there is a glare area (whether the position information of the glare area is stored), and the processing proceeds to S1604 when there is a glare area because the image is one for which Yes is determined in S1602. The processing proceeds to S512 when there is no glare area.

In step S1604, image correction processing is executed by binarization using the binarization threshold value obtained in S1601 for the glare area in the captured image, and the processing proceeds to S512.

As described above, according to the fourth embodiment, even in the case where a glare area is present in the captured image, a configuration can be made so that the processing proceeds to the subsequent stage without displaying a message as long as a glare is within such a degree that the situation can be handled with image correction.

### OTHER EMBODIMENTS

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-241078, filed Dec. 15, 2017, which is incorporated by reference herein in its entirety.

What is claimed is:

1. An information processing apparatus comprising:
a memory that stores a program; and
a processor that executes the program to perform:
determining whether a reflecting portion that strongly reflects a light of a light source is included in a captured image; and
displaying a message for prompting a user to change a shooting method when having determined that the reflecting portion is included in the captured image.

2. The information processing apparatus according to claim 1,
wherein when having determined that the reflecting portion is not included in the captured image, the processor executes processing in a subsequent stage on the captured image.

3. The information processing apparatus according to claim 1,
wherein when having determined that the reflecting portion is not included in the captured image, the processor executes processing in a subsequent stage on an image newly captured at this time.

4. The information processing apparatus according to claim 2,
wherein the processing in a subsequent stage is character recognition processing.

5. The information processing apparatus according to claim 1,
wherein when having determined that the reflecting portion is included in the captured image, the processor displays the message for prompting the user to change the shooting method and a guide indicating a position of the reflecting portion.

6. The information processing apparatus according to claim 1,
wherein when the reflecting portion is included in the captured image, the processor determines whether a position of the reflecting portion overlaps a position of a processing target region based on layout information defining the processing target region of a subject in advance, determines that the reflecting portion is included in the captured image when the position of the reflecting portion overlaps the position of the processing target region, and determines that the reflecting portion affecting processing in a subsequent stage is not included in the captured image when the position of the reflecting portion does not overlap the position of the processing target region.

7. The information processing apparatus according to claim 1,
wherein when the reflecting portion is included in the captured image, the processor acquires a plurality of images having the reflecting portions at different positions, and detects a position of a character string region for each of the plurality of acquired images, determines that the reflecting portion is included in the captured image when the detected position of the character string region changes between the plurality of images, and determines that the reflecting portion affecting processing in a subsequent stage is not included in the captured image when the detected position of the character string region does not change between the plurality of images.

8. The information processing apparatus according to claim 1,
wherein when having determined that the reflecting portion is included in the image, the processor determines whether the reflecting portion can be handled with image correction, and
displays the message for prompting the user to change the shooting method when having determined that the reflecting portion cannot be handled with the image correction.

9. The information processing apparatus according to claim 8,
wherein when having determined that the reflecting portion can be handled with the image correction, the processor executes processing of the image correction on the captured image, and
performs control so as to execute processing in a subsequent stage on the image subjected to the image correction.

10. An information processing method executed by an information processing apparatus, the method comprising:
determining whether a reflecting portion that strongly reflects a light of a light source is included in a captured image; and
displaying a message for prompting a user to change a shooting method when having determined that the reflecting portion is included in the captured image.

11. The information processing method according to claim 10,
wherein when having determined that the reflecting portion is not included in the captured image, the computer further executes processing in a subsequent stage on the captured image.

12. The information processing method according to claim 10,
wherein when having determined that the reflecting portion is not included in the captured image, the computer further performs control so as to execute processing in a subsequent stage on an image newly captured at this time.

13. The information processing method according to claim 11, wherein the processing in a subsequent stage is character recognition processing.

14. The information processing method according to claim 10,
wherein when having determined that the reflecting portion is included in the captured image, the computer displays the message for prompting the user to change the shooting method and a guide indicating a position of the reflecting portion.

15. The information processing method according to claim 10,
wherein when the reflecting portion is included in the captured image, the computer determines whether a position of the reflecting portion overlaps a position of a processing target region based on layout information defining the processing target region of a subject in advance, determines that the reflecting portion is included in the captured image when the position of the reflecting portion overlaps the position of the processing target region, and determines that the reflecting portion affecting processing in a subsequent stage is not included in the captured image when the position of the reflecting portion does not overlap the position of the processing target region.

16. The information processing method according to claim 10,
wherein when the reflecting portion is included in the captured image, the computer acquires a plurality of images having the reflecting portions at different positions, and detects a position of a character string region for each of the plurality of acquired images, determines that the reflecting portion is included in the captured image when the detected position of the character string region changes between the plurality of images, and determines that the reflecting portion affecting processing in a subsequent stage is not included in the captured image when the detected position of the character string region does not change between the plurality of images.

17. The information processing method according to claim 10,
wherein when having determined that the reflecting portion is included in the image, the computer determines whether the reflecting portion can be handled with image correction, and
displays the message for prompting the user to change the shooting method when having determined that the reflecting portion cannot be handled with the image correction.

18. The information processing method according to claim 17,
wherein when having determined that the reflecting portion can be handled with the image correction, the computer executes processing of the image correction on the captured image, and
performs control so as to execute processing in a subsequent stage on the image subjected to the image correction.

19. A non-transitory computer readable storage medium storing a program for causing a computer to perform:
determining whether a reflecting portion that strongly reflects a light of a light source is included in a captured image; and
displaying a message for prompting a user to change a shooting method when having determined that the reflecting portion is included in the captured image.
